(19) United States
(12) Patent Application Publication
(10) Pub. No.: US 2022/0036409 A1
(43) Pub. Date: Feb. 3, 2022

(54) Multilingual Tag-Based Review System

(71) Applicant: Yeogirl Yun, Sunnyvale, CA (US)

(72) Inventor: Yeogirl Yun, Sunnyvale, CA (US)

(21) Appl. No.: 17/290,422

(22) PCT Filed: Nov. 4, 2019
(86) PCT No.: PCT/US2019/059584

§ 371 Date: Apr. 30, 2021

Related U.S. Application Data
(60) Provisional application No. 62/770,767, filed on Nov. 22, 2018.

(51) Int. Cl. G06Q 30/02; G06F 16/23; G06F 40/42; G06F 40/169

(52) U.S. Cl. CPC G06Q 30/0282; G06F 40/169; G06F 40/42; G06F 16/2379

(57) ABSTRACT

A multilingual tag-based review system where users from around the world, can browse and submit review over the Internet, for product purchases or other reviews related to the user's interests. The system has a server with a database. The database has authorized, pre-written tags and stored ratings associated with the product or the items being reviewed, and displays the tags and ratings on the website with the product or item being reviewed. Users can quickly gauge the ratings in their own language to determine their interest in the item or whether or not to purchase the product by browsing the reviews or leaving a review of the product, if the user has purchased the product, or item of interest.

### CROSS-REFERENCE TO RELATED APPLICATIONS

This application claims the benefit under 35 U.S.C. § 119(e) of U.S. Provisional Patent Application Ser. No. U.S. 62/770,767 2018-11-22, filed on 2018 Nov. 22, the contents of which are incorporated herein by reference in their entirety.

### FIELD OF THE INVENTION

The present invention is in the technical field of review systems and more particularly to a multi-lingual tag-based review system and method to streamline review processes and provide the most accurate review information as possible to users.

### BACKGROUND

Currently, the idea of “tags” to sort information online isn't new, and has been used on websites, blogs, etc. for years. However, no one has applied this technology to consolidating product reviews across multiple languages. Additionally, to date, there's been no clean or easy way to aggregate product reviews across different languages.

Product reviews from different languages are currently handled in one of two ways:

1) Separate localized e-commerce sites, featuring only reviews from users who shopped for the product on that particular page (ex: Amazon Japan, Amazon US, etc.)

2) E-commerce product pages with consolidated user reviews across multiple languages. This becomes a messy user experience if the user is able to read only some of what's been posted.

Users don't have the time or the desire to read hundreds of online user reviews for a product. Typically, a user will look at an overall rating and base their buying decision off of that rating. However, many reviews and star ratings don't give a complete assessment that is useful to the consumer. In this age of global consumerism, having the ability to make available a system for reviewing products that are sold world-wide to everyone and making those reviews easy to understand, write and aggregated is essential to ecommerce platforms.

Therefore, there is a need for a method for multi-lingual tag-based review to streamline review processes and provide the most accurate review information as possible to users, overcoming the limitations of the prior art.

### SUMMARY

The present invention overcomes the limitations of the prior art by providing a computerized method for a multilingual tag-based review. First a user logs on to a website selling one or more than one product or service. Then, the user selects a language to use for a transaction. Next, the user opens a user center for placing and tracking orders. Next, the user opens an orders list and selects a product to review. Then, a determination is made as to whether a review has already been entered for the one or more than one product or service. Next, the user enters a comment about the selected product or service. Then, the user rates the product or service with stars. Next, the user can select authorized pre-written tags to describe the product ore service. Then, the user submits a review, where the review comprises the comment, the stars rating and the selected tags. The user can repeat the review process until all reviews are complete. The system also notifies a user to log on to the website in step a) and leave a review, when an order is delivered to the user. Additionally, the review is stored in a storage. The review is associated with the item or product selected by the user for review.

The system also creates one or more than one new tag for the review. The one or more than on tags can be reviewed manually, automatically, or both manually and automatically for appropriateness and to prevent duplication of tags. A stars rating is calculated to be included in the submitted review. The number of authorized pre-written tags used in the review is determined and a count for the authorized pre-written tags used is incremented to keep track of the reviews and ratings. One or more than one new tag and one or more than one unique identifier are assigned. One or more than one unique identifier is associated with the selected item.

The method also has the steps of creating one or more than one new tag for the review; storing the one or more than one new tag in a storage; calculating a stars rating to include the submitted review; determining the number of authorized pre-written tags used in the review and incrementing a count for the authorized pre-written tags used; assigning the one or more than one new tag one or more than one unique identifier; and associating the one or more than one unique identifier with the selected item.

There is also provided a computerized method for browsing a multilingual tag-based review. First a user logs in to a website. Then, a language to view reviews is selected. Next, a product, service or other reviewed items web page is opened. Then, a web page containing submitted reviews is selected. Next, the submitted reviews are viewed, where the submitted reviews comprise a stars rating for the product, service or other reviewed item. Finally, viewing user submitted tags.

The method also has the steps of changing the selected languages. Then, automatically updating the web page being view to a new language. Finally, changing the tag labels to the new language without altering the presented tags or stars.

The one or more than one tag comprises positive tags, negative tags, or both positive tags and negative tags. Also, the one or more than one tag in the review are sortable and scrollable, where most used tags, either positive or negative are displayed to the user first.

There is also provided a multilingual tag-based review system having: a server, where the server comprises executable instructions for translating text in to a plurality of languages; a database operably connected to the server, where the database comprises one or more than one review, where the one or more than one review comprises: tags and star ratings associated to one or more than one product, service or reviewable item; and one or more than one web site operably connected to the server.

The tags can be pre-written tags and pre-approved.

The reviews are associated with the one or more than one product, service, and other reviewable item using a unique identifier.

The system has executable instructions stored on a machine-readable medium to: collect information for review submissions regarding the one or more than one product, service, and other reviewable item; store in the database the collected information; store in the database the one or more than one tag associated with the products, the services, and the other reviewable items, a star rating; and each individual user's review.

There are also executable instructions in the system to: update an aggregation of the tags; update a star rating; store in the database the updated aggregation of the tags and the updated star rating; and update the item associated with the updated aggregation of the tags and the updated star rating for easy retrieval and presentation. The system furthermore has executable instructions on the server to access all the tags and star ratings for the items stored in the database for display to a users in the user's selected language.

### BRIEF DESCRIPTION OF THE DRAWINGS

These and other features, aspects and advantages of the present invention will become better understood with regard to the following description, appended claims, and accompanying figures where:

FIG. 1 is a flowchart of some steps of a computerized method for a method for multilingual tag-based review for selecting a review, according to one embodiment;

FIG. 2 is a flowchart of some steps of a computerized method for a method for multilingual tag-based review for creating a review, according to one embodiment;

FIG. 3 is a flowchart of some steps of a computerized method for a method for multilingual tag-based review for browsing a review, according to one embodiment;

FIG. 4 is a screenshot of a multilingual tag-based product review request presented to a user.

FIG. 5 is a screenshot of an English language tag-based product review shown on a web site;

FIG. 6 is a screenshot of a Korean language tag-based product review of the product shown in FIG. 5;

FIG. 7 is a screenshot of a Chinese language tag-based product review of the product shown in FIG. 5;

FIG. 8 is a screenshot of a summary statistical review of all reviews regardless of the language used; and

FIG. 9 is a diagram of a multilingual tag-based review system.

### DETAILED DESCRIPTION OF THE INVENTION

The present invention overcomes the limitations of the prior art by providing a method and a system for multi-lingual tag-based review to streamline review processes and provide the most accurate review information as possible to users. This new tag-based review features pre-approved, pre-written tags that are linked to a translated version across localized e-commerce pages. This is the first online rating/review to utilize text tags instead of written reviews for users to expand on their feelings for a product they've purchased from a platform. Rating “tags” consisting of both positive and negative sentiments as they relate to their experience with the product, service or item being reviewed. The new tagging review method filters the most popular, agreed upon descriptions of it to the top of the list. It's a simple way to get accurate information on a product from hundreds of different people who've already purchased it.

In lieu of writing a review, users choose from a series of tags, both good and bad, to describe their experience with the product. The tags are aggregated over time, with the most popular tags surfacing to the top of the product's review section. There are approximately twenty pre-written tags, each of which is linked to a translated version across each localized e-commerce page or review page. users will also have the option to create their own review tags. For quality control, an editorial team can review each new tag submission and decide whether it is relevant to the product and approve/deny and localize as needed.

All tags are localized in to all supported languages, such as, for example, Korean, Chinese and English, and work on a variety of platforms including e-commerce platform and review website. The reviews, in all the various languages, are then aggregated on to a given webpage in the user's selected language.

This method of consolidating reviews across multiple languages help to paint a fuller picture of what users think of products, service an other reviewable items around the world. It also provides users much more information than they would normally have. The present invention is able to provide a user with much richer review info without being cumbersome or confusing to understand.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and computer programs according to various embodiments disclosed. In this regard, each block in the flowchart or block diagrams can represent a module, segment, or portion of code, that can comprise one or more executable instructions for implementing the specified logical function(s). It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

In the following description, certain terminology is used to describe certain features of one or more embodiments of the invention.

Various embodiments provide a multilingual tag-based review. One embodiment of the present invention provides a multilingual tag-based review. In another embodiment, there is provided a method for using the system. The system and method will now be disclosed in detail.

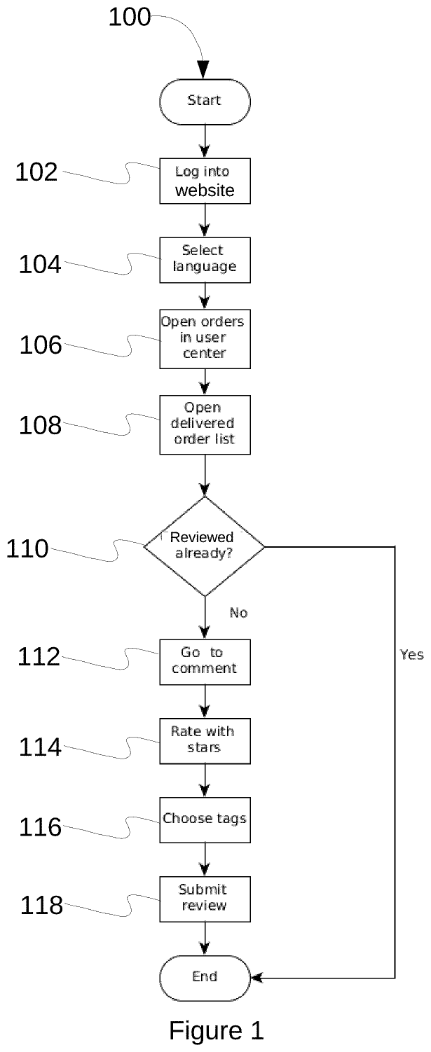

Referring now to FIG. 1, there is shown a flowchart of some steps of a computerized method for a method for multilingual tag-based review for selecting a product review, according to one embodiment. As can be seen, when an order is delivered to the user, a notification is triggered within the system 900 asking a user to leave a review on the product. First, the user logs 102 into a website. Then, the user selects a language 104 to use. Next, the user opens one or more than one order 106 that the use has previously placed. Then, the user opens the delivered product orders list 108 and selects a product to review. Next, the user determines if they have commented on the product order previously 110. Then, if the user has not previously commented on the product order, the user goes to the comment area 112 of the web page. Next, the user rates 114 the product order with stars. The user can leave a traditional star rating, but also select from a list of positive and negative tags. Then, the user selects tags 116 that express how the user felt about the product order. In lieu of writing a review, users choose from a series of tags, both good and bad, to describe their experience with the product. The reviews are aggregated over time, with the most popular tags surfacing to the top of the product's review section. Finally, the user submits a review 118 of the product order using standard web interface controls. When the user selects “Submit,” the star ratings and user selected tags are sent to the system 900 for storage and the review web page on the product page is updated. Additionally, all the information submitted by the user is updated for all the languages supported by the platform.

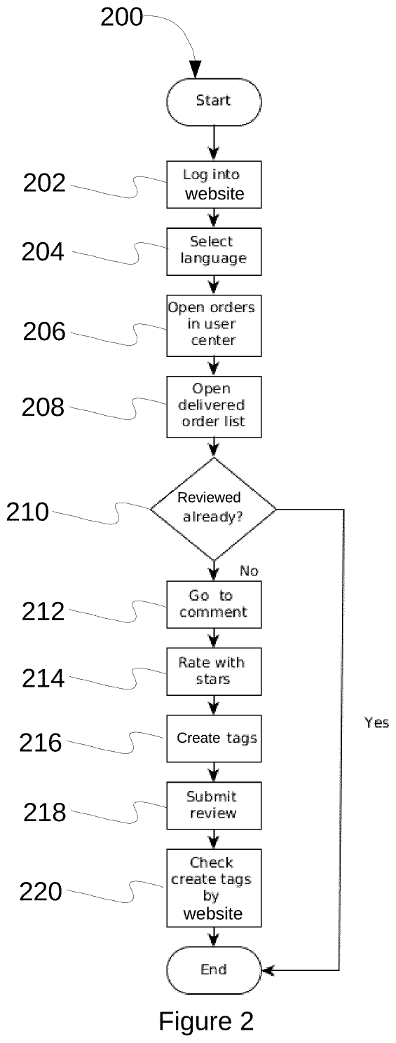

Referring now to FIG. 2, there is shown a flowchart of some steps of a computerized method for a method for multilingual tag-based review for creating a review, according to one embodiment. First, the user logs 202 into the e-commerce website. Then, the user selects a language 204 to use. Then, the user opens orders in the user center 206. Next, the user opens a delivered order list 208. Then, the user determines if they have reviewed already on the order 210. Next, the user goes to a comment 212. Then, the user rates the order with stars 214. Then, the users creates one or more than one tag 216 to be stored in the system 900. Next, the user submits the review 218. Finally, the one or more than one tag created in the review are checked 220 by executable code in the system 900 to see if the one or more than one tag is new, appropriate and not a duplicate of an existing tag. Any new tags can be added to the database 916. Also, new tags are assigned one or more than one unique identifier in the system 900 and stored with the selected item to be used in future reviews by different users. Additionally, once accepted and stored, the new tags are translated by the system 900 into different languages by code executable on the server 914 when they are presented so that the new tags can be used world wide.

Optionally, the system 900 does not review and adjust or reject the user created tags. Instead, the system 900 does not pre-screen the tags but allows as many cloud-based tags that can be gathered and suggested. In this option, irrelevant tags may not get support from other users and may become obsolete without the need for any intervention.

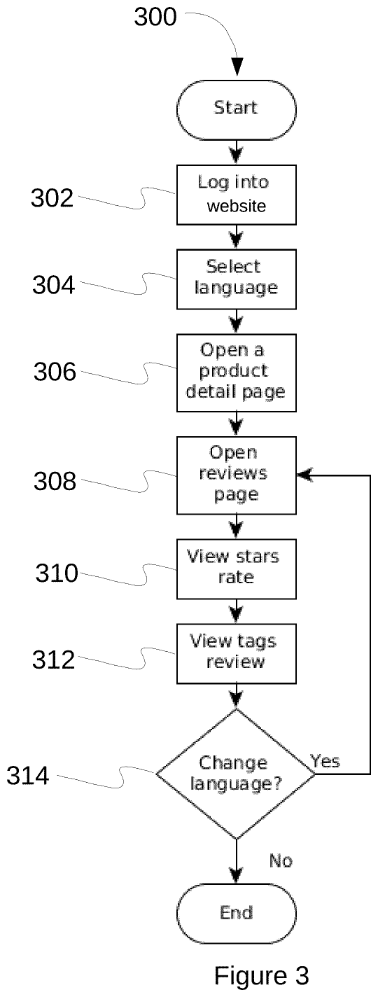

Referring now to FIG. 3, there is shown a flowchart of some steps of a computerized method for a method for multilingual tag-based review for browsing a review, according to one embodiment. First, a user logs into a website 302. Then, the user selects a language 304 to view the reviews. Next, the user opens up a product, service or other reviewed items web page 306. Then, the user selects the web page containing submitted reviews 308. Then, the user can review a stars rating 310 for the product, service or other reviewed item. Next, the user can review the one or more than tags 312 submitted by users in previous reviews. Optionally, the user can change languages and the system 900 will update the web page being viewed by the user to the new language. None of the stars ratings 310 or the tags 312 will be altered, only the language will be altered.

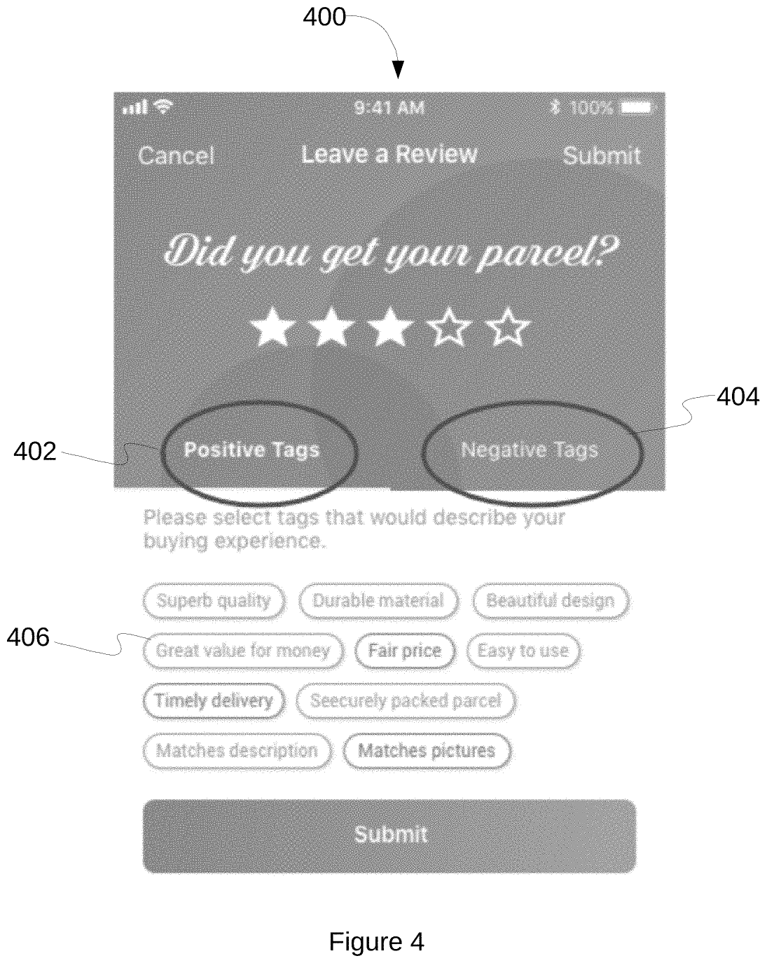

Referring now to FIG. 4, there is shown a screenshot of a multilingual tag-based product review request 400 presented to a user. As can be seen, the review request 400 comprises both positive tags 402 and negative tags 404. From the selection of positive tags 402 or negative tags 404, the system 900 populates the review request 400 with the most used tags in either category 402 and 404. As can be appreciated, if there are more tags than fit on the available tag area, the review request 404 form will allow the user to scroll through all the tags. Although not shown in this Figure, the user can optionally submit a new tag to add to the list of available tags. The new tag submission will then be flagged by the system 900 for review. The review process can be automated, manual, or both automated and manual. Automated review involve standard machine learning and artificial intelligence that is known in the industry. Additionally, operations personnel can review the new tag and determine if the new tag will be added to the list after the automated review process or instead of the automated review process.

As will be understood by those will skill in the art with reference to this disclosure, there are many variations other than the simple positive vs. negative statistics. Tags can also be categorized in many different classifications, such as, for example, “price”, “design”, “customer support”, and/or “product durability”. Additionally, the system can provide detailed statistics such as 40% of the users provided positive feedback on a price category but 20% users provided negative feedback on a customer support category. There can be many tags in each category. Categories can also apply to different country/language users to provide other statistics. For example, Asian users (for example, Korean, Japan, and/or Chinese) provide 80% positive feedback while Western (for example, US and EU countries) provided only 65% positive feedback on a reviewed product. In other words, the tag-based multi-lingual review system 900 can provide a holistic review of a product at a global level and users can fully understand the product's feedback globally using these types of simple category and tags statistics.

The system 900 can also provide other statistics, such as, for example, users that gave positive scores in “price” category tags, also provided positive scores in “design” category, etc. In essence, the tag-based multi-lingual review system 900 opens up a whole new way of understanding complex users feedback in a very “ready-to-make-purchase-decision” fashion, that boosts conversion rates, that is the most important metric of any e-commerce platform.

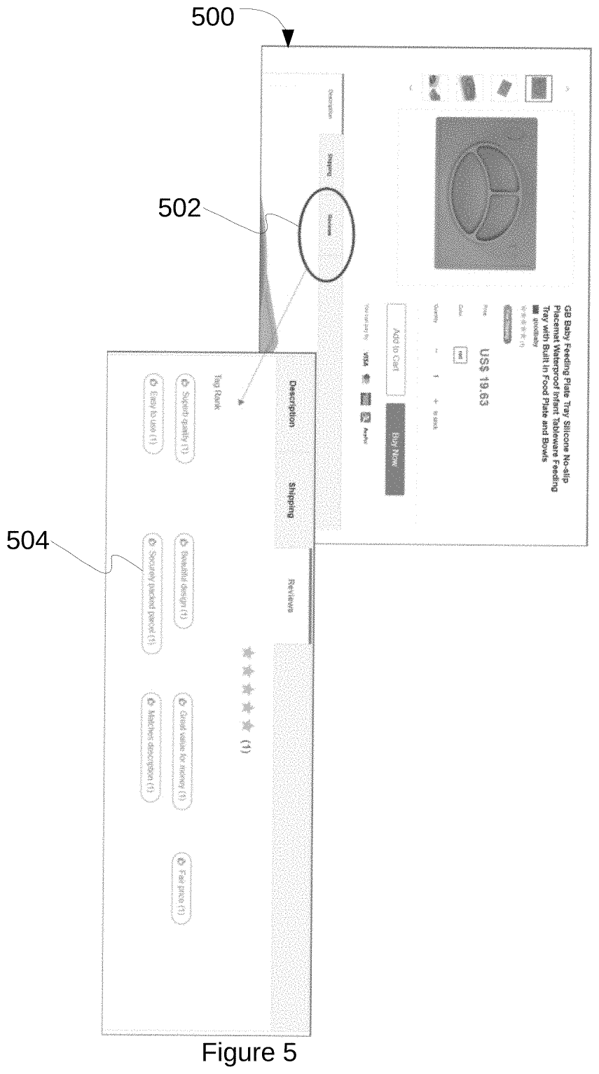

Referring now to FIG. 5, there is shown a screenshot of an English language tag-based product review 500 shown on a website. As can be seen, when a user selects the “Reviews” browser tag 502, the English language tags along with the stars rating for the product shown are displayed 504.

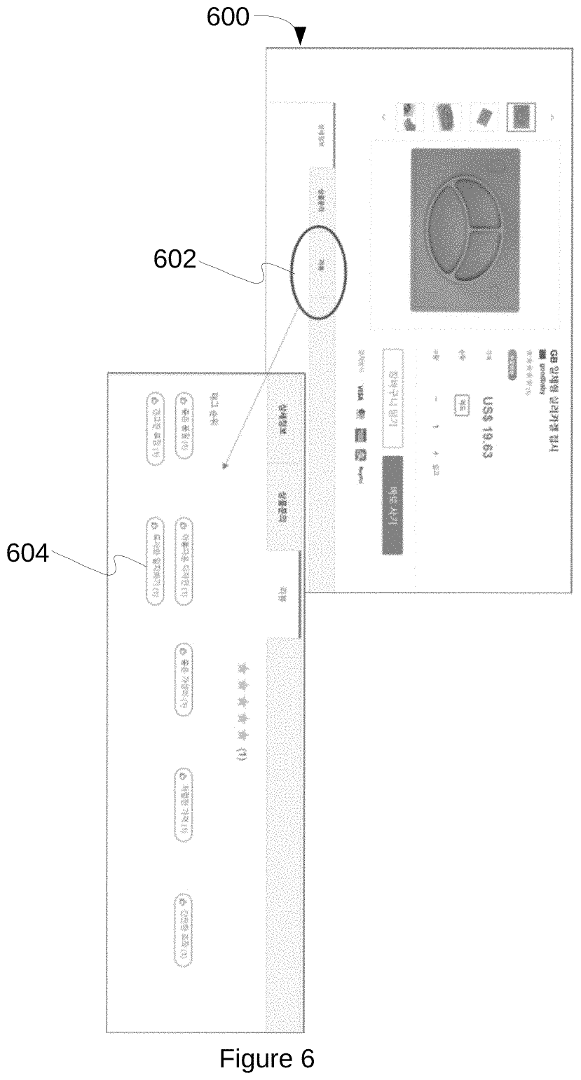

Referring now to FIG. 6, there is shown a screenshot of a Korean language tag-based product review 600 of the product shown in FIG. 5. In this example, the product is exactly the same as the product in FIG. 5. However, the selected language in this case is Korean, so all the browser elements, including the review browser tab 502 and the tags 604 are updated by the system 900 and the method 100 and presented to the user are in Korean.

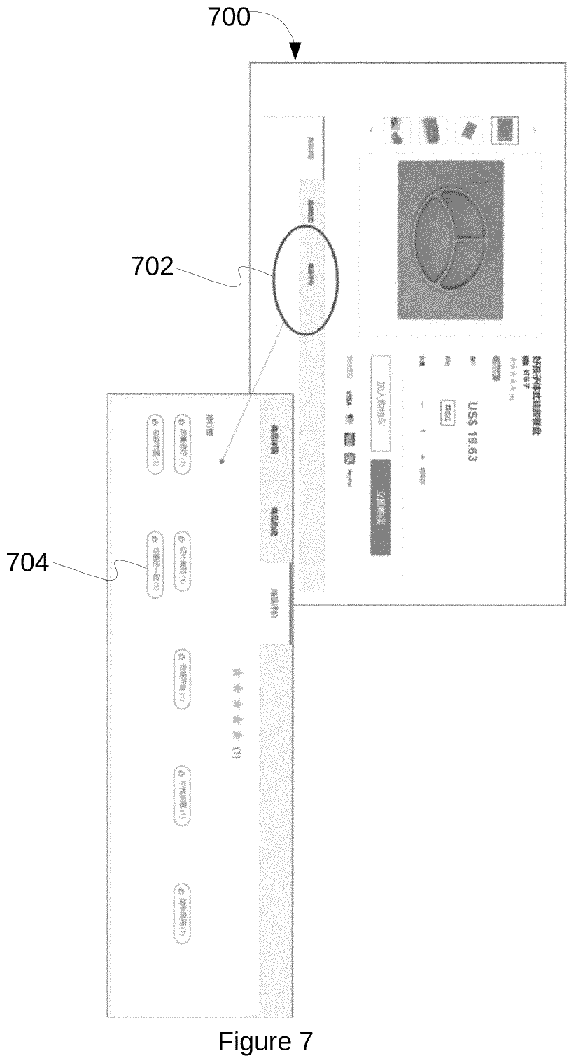

Referring now to FIG. 7, there is shown a screenshot of a Chinese language tag-based product review 700 of the product shown in FIG. 5. In a similar fashion as FIG. 5 and FIG. 6, the user in this example has selected Chinese as their native language. The system 900 extracts all the localize information for all the browser elements 702 and the tags 704 that are presented to the user in the selected language, in this case Chinese.

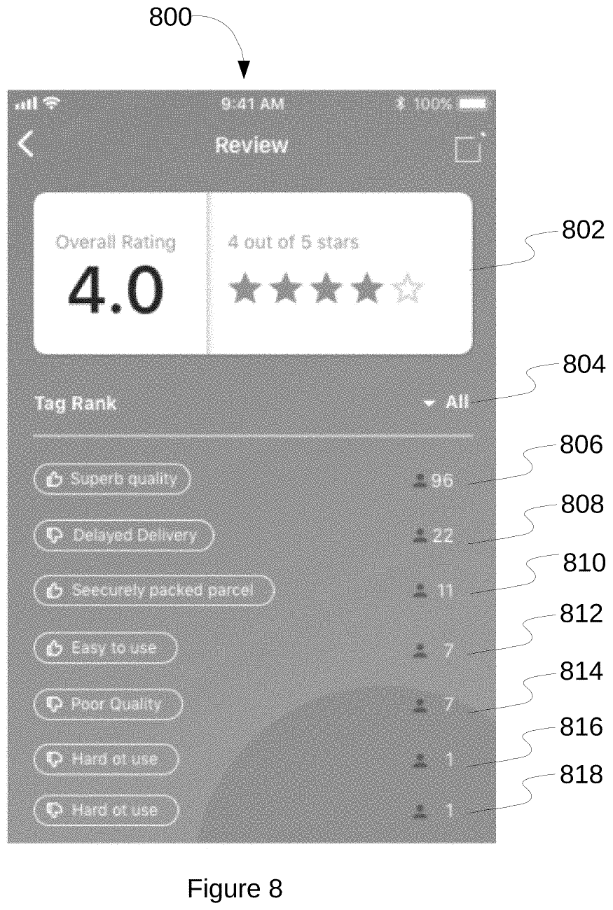

Referring now to FIG. 8, there is shown a screenshot of a summary statistical review 800 of all reviews regardless of the language used. As can be seen, both a stars review rating 802 and top submitted tags 806, 808, 810, 812, 814, 816, and 818 are presented to a user. Over time, many different tags 806-818 across multiple languages will accumulate from customer reviews. All tags 806-818 will be aggregated across all localized pages and displayed in the user's preferred language, with the most often selected tags presented first along with the traditional star rating system 802.

All tags will be aggregated across all localized pages and displayed in the shopper's preferred language, as will the traditional star rating system. Additionally, the user can sort the tags using the sort option element 804.

As can be appreciated, this is only one of many different ways that the multilingual tag-based reviews can be accessed and displayed to a user. The examples presented herein are not meant to limit the scope of the invention, but only to show one, of a plurality, of ways that the system 900 and methods 100, 200 and 300 can be used to enhance user interaction and help to drive website traffic and potential sales.

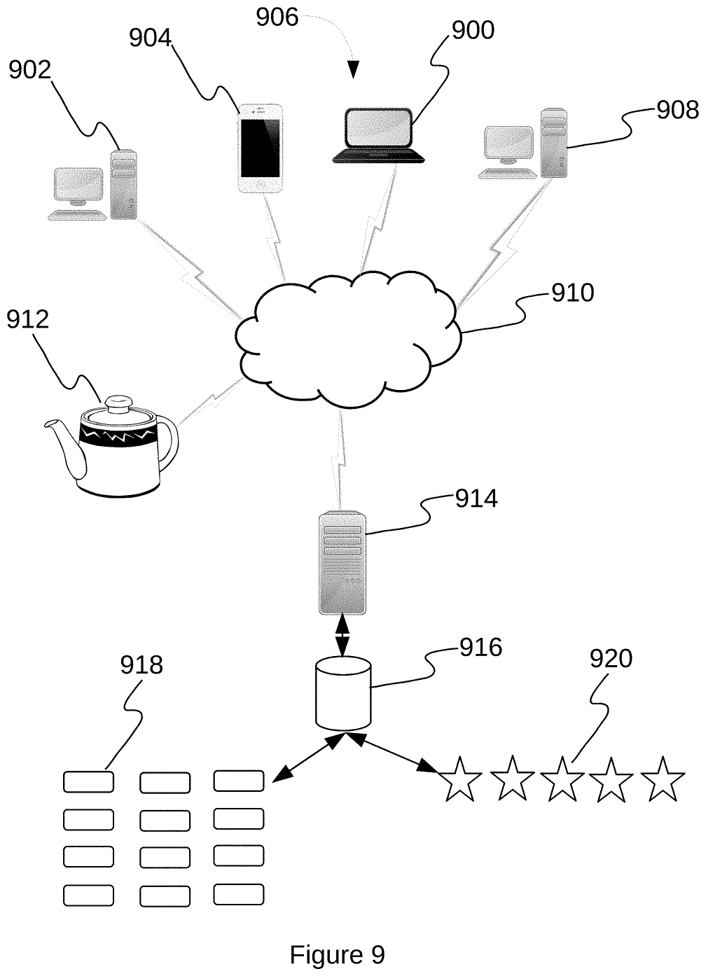

Referring now to FIG. 9, there is shown a diagram of a multilingual tag-based review system 900. As can be seen users 902, 904. 906, and 908 from around the world, shopping on the Internet 910, purchase or consider purchasing a product 912. A server 914 access a database 916 comprising authorized, pre-written tags 918 and ratings 920 associated with the product 912 and displays the tags 918 and ratings 920 on the e-commerce website with the product 912. Users can quickly gauge the ratings in their own language to determine if they want to purchase the product 912 by browsing the reviews or leave a review of the product 912 if the user has purchased the product 912.

When lone or more than one user 902-908 finds a product, service or any other item that can be rated on the Internet that supports the methods described herein, the multilingual tag-based review system will be able to present websites and web pages to the one or more than one user 902-908 in any language supported.

For this example, the users 902-908 are viewing, purchasing or submitting reviews about the product 912 over the Internet 910 in any language. The server 914 executes instructions stored on a machine-readable medium to collect the information for review submissions about the product 912 and to store that collected information in a database 916. The tags 918 submitted for review are not stored with a specific language, but by associating the one or more than one tag 918 with the product 912. In this manner, the tags 918 are language independent and uniquely attached to the product 912. As can be appreciated, the same system works as well for services and/or other items not related to e-commerce. Additionally, a star rating 920 also stored with the individual user's 902-908 review submission. The server 914 also executes instructions to update the aggregation of the tags 918 and the star rating 920 for easy retrieval and presentation in the future. The aggregate information is stored in the database 912 and associated with the product 912.

Users 902-908 browsing multilingual tag-based cause the server 914 to execute stored machine-readable instructions that access all the tags 918 and star ratings 920 for the product 912 stored in the database 916. All the tags 918 and the star ratings 920 for the product 912 are made available to the website for display to the users 902-908 depending on the user's 902-908 actions. Additionally, the aggregate information for the tags 908 and the star rating 920 are retrieved and can be presented to the user as a quick review depending on how the websites is constructed to use the information. The server 914 also comprises instructions for language localization of the information stored in the database 916 so that the website will present the information in the language selected by the user 902-908.

As will be understood by those with skill in the art with reference to this disclosure, the e-commerce examples shown above are not meant to be limiting. As will be appreciated, there are many other examples of websites that are not related to e-commerce, such as, for example, movie review websites, album/song review websites, video websites, restaurant reviews, or anyplace that users are able to rate something, where the described systems and methods can be used. The applications for the present invention in the field of international travel can be huge as travelers can quickly and easily find reviews for foreign products and places in their native language without worrying about translating the foreign language reviews.

What has been described is a new and improved system for a multi-lingual tag-based review system to streamline review processes and provide the most accurate review information as possible to users, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A computerized method for a multilingual tag-based review, the method comprising the steps of:
a) logging a user on to a website;
b) selecting a language to use;
c) opening a user center;
d) open an orders list and selecting a product to review;
e) determining if a review has already been entered;
f) entering a comment;
g) rating the item with stars;
h) selecting authorized pre-written tags;
i) submitting a review, where the review comprises the comment, the stars rating and the selected tags;
j) repeating steps d) through i) until all reviews are complete.

2. The computerized method of claim 1, further comprising the step of notifying a user to log on to the website in step a) and leave a review, when an order is delivered to the user.

3. The computerized method of claim 1, further comprising the step of storing the review in a storage.

4. The computerized method of claim 1, further comprising the step of associating the review with the user selected item in step d).

5. The computerized method of claim 1, further comprising the steps of:
a) creating one or more than one new tag for the review;
b) reviewing the one or more than one new tag manually, automatically, or both manually and automatically for appropriateness and to prevent duplication of tags;
c) storing the one or more than one new tag in a storage;
d) calculating a stars rating to include the submitted review;
e) determining the number of authorized pre-written tags used in the review and incrementing a count for the authorized pre-written tags used;
f) assigning the one or more than one new tag one or more than one unique identifier; and
g) associating the one or more than one unique identifier with the selected item.

6. The computerized method of claim 1, further comprising the steps of:
a) creating one or more than one new tag for the review;
b) storing the one or more than one new tag in a storage;
c) calculating a stars rating to include the submitted review;
d) determining the number of authorized pre-written tags used in the review and incrementing a count for the authorized pre-written tags used;
e) assigning the one or more than one new tag one or more than one unique identifier; and
f) associating the one or more than one unique identifier with the selected item.

7. A computerized method for browsing a multilingual tag-based review, the method comprising the steps of:
a) logging a user in to a web site;
b) selecting a language to view reviews;
c) opening a product, service or other reviewed items web page;
d) selecting a web page containing submitted reviews;
e) viewing the submitted reviews, where the submitted reviews comprise a stars rating for the product, service or other reviewed item; and
f) viewing user submitted tags.

8. The method of claim 7, further comprising the steps of:
a) changing the selected languages;
b) automatically updating the web page being view to a new language; and
c) changing the tag labels to the new language without altering the presented tags or stars.

9. The method of claim 1, where the one or more than one tag comprises positive tags, negative tags, or both positive tags and negative tags.

10. The method of claim 1, where the one or more than one tag in the review are sortable and scrollable, where most used tags, either positive or negative are displayed to the user first.

11. A multilingual tag-based review system comprising:
a) a server, where the server comprises executable instructions for translating text in to a plurality of languages;
b) a database operably connected to the server,
where the database comprises one or more than one review, where the one or more than one review comprises: tags and star ratings associated to one or more than one product, service or reviewable item; and
c) one or more than one web site operably connected to the server.

12. The system of claim 11, where the tags are pre-written tags and pre-approved.

13. The system of claim 12, where the reviews are associated with the one or more than one product, service, and other reviewable item using a unique identifier.

14. The system of claim 11 further comprising executable instructions stored on a machine-readable medium to:
a) collect information for review submissions regarding the one or more than one product, service, and other reviewable item;
b) store in the database the collected information;
c) store in the database the one or more than one tag associated with the products, the services, and the other reviewable items;
d) store in the database a star rating; and
e) store in the database each individual user's review.

15. The system of claim 11 further comprising executable instructions to:
a) update an aggregation of the tags;
b) update a star rating;
c) store in the database the updated aggregation of the tags and the updated star rating; and
d) update the item associated with the updated aggregation of the tags and the updated star rating for easy retrieval and presentation.

16. The system of claim 11 further comprising executable instructions on the server to access all the tags and star ratings for the items stored in the database for display to a users in the user's selected language.
